(19) United States
(12) Patent Application Publication
(10) Pub. No.: US 2016/0105047 A1
(43) Pub. Date: Apr. 14, 2016

(54) Mobile device mounting and charging system

(71) Applicant: AIBC INTERNATIONAL, LLC, Ithaca, NY (US)

(72) Inventor: Yang Cui, Ithaca, NY (US)

(21) Appl. No.: 14/874,581

(22) Filed: Oct. 5, 2015

Related U.S. Application Data
(60) Provisional application No. 62/062,278, filed on Oct. 10, 2014.

(51) Int. Cl. H02J 7/00

(52) U.S. Cl. CPC H02J 7/0044; H02J 7/0052

(57) ABSTRACT

A mobile device mounting and charging system having a device case with female connection points on the back of the mobile device case connected to the device through charging connections. A charging base has male contacts for mating with the female connection points, preferably in the form of pogo pins, with a magnet that maintains base and case connection. The charging base is connected to a power source.

### REFERENCE TO RELATED APPLICATIONS

This application claims one or more inventions which were disclosed in Provisional Application No. 62/062,278, filed Oct. 10, 2014, entitled “Mobile device mounting and charging system”. The benefit under 35 USC §119(e) of the U.S. provisional application is hereby claimed, and the aforementioned application is hereby incorporated herein by reference.

### BACKGROUND OF THE INVENTION

1. Field of the Invention

The invention pertains to the field of mounting and charging systems. More particularly, the invention pertains to mounting and charging systems for portable devices such as mobile phones or the like.

2. Description of Related Art

With prior art mounts, a user accomplishes charging by finding a cable and plugging in their device—cell phone, GPS, MP3 player—every time they are in their vehicle. These mounts hold phones with clamp-style devices that require two hands and multiple actions. Apple's Lightning® or 30-pin connectors or various forms of micro-USB connections are conventionally used in charging portable devices.

Current wireless charging systems are based on inductive charging that uses an electromagnetic field to transfer energy between two objects. Induction chargers typically use an induction coil to create an electromagnetic field from the charging base, and also need a receiver induction coil in the portable device. The disadvantages of wireless charging systems are significant compared with our invention:
1. Low efficiency and slower charging vs. our direct contact.
2. More expensive vs. lower cost.
3. Less reliable with multiple components vs. simple structure, less parts.
4. Bigger size of base vs. smaller size of base, this will allow applications with limited space.
5. Horizontal position only vs. vertical & horizontal, the base can be embedded on the wall and mobile device can be mounted vertically and charging.

U.S. Pat. No. 7,311,526 shows a “Magnetic connector for electronic devices”, as is used by Apple on some portable laptop computers.

### SUMMARY OF THE INVENTION

The invention is designed to making mounting and charging a mobile device (e.g. smartphone) in a vehicle or other locations achievable with one hand-motion. The invention has a device case with a female connection points on the back, which are connected to the mobile device through the normal charging connector—micro-USB phone charging connections, or Lightning® or 30-pin charging connections for Apple devices. A charging base is provided which has male contacts for mating with the female contacts, preferably in the form of pogo pins. The base is connected to a power source for charging the device.

A magnet in the base attracts a steel plate in the case to maintain base and case connection. Magnetic mounting is designed so that the device can be used in any directional orientation and maintain mobile device charging.

The invention avoids having to search for a cord and plugging it in to charge every time, and securing the phone on the dash becomes simple with one motion and one hand, instead of multiple actions and a two-handed operation. For out of vehicle usage, a charging base can be embedded in a wall, the mobile device can be attached and detached vertically, and charged with the same process.

This invention also helps make driving safer, minimizing the need to hold the phone in one hand while on speakerphone and driving (which is a traffic violation in many states), and setting down the phone within speakerphone range while keeping one hand on the steering wheel becomes easy.

### BRIEF DESCRIPTION OF THE DRAWING

FIG. 1 shows a front view of a charging base.

FIG. 2 shows an exploded diagram of the charging base.

FIG. 3 shows a charging base on a tabletop, with a charging wire input.

FIG. 4 shows a back view of a mobile device case for mating with the charging base.

FIG. 5 shows a front view of a mobile device case for mating with the charging base.

FIG. 6 shows an exploded view of a mobile device case for mating with the charging base.

FIG. 7 shows a side view of a pogo pin for use with the charging base.

FIG. 8 shows a cut-through view of the pogo pin of FIG. 7.

FIG. 9 shows a mobile device mounted on the charging base on the dashboard of the vehicle.

FIG. 10 shows the charging base on a mobile device case.

FIGS. 11 and 12 show a charger base in an embodiment with the base integrated into an AC plug.

FIG. 13 shows a top view of a CD-slot mount which allows mounting the charging base, or other devices, using the CD-slot of a car audio system.

FIG. 14 shows an exploded view of the parts of the CD-slot mount.

FIG. 15 shows a perspective view of the CD-slot mount.

FIG. 16 shows a mobile device attached to a charging base, which is supported by a mount inserted into a car CD player CD slot.

FIG. 17 shows an interior of a car, with charging base locations.

FIG. 18 shows an embodiment of the charging base for tablet computers.

### DETAILED DESCRIPTION OF THE INVENTION

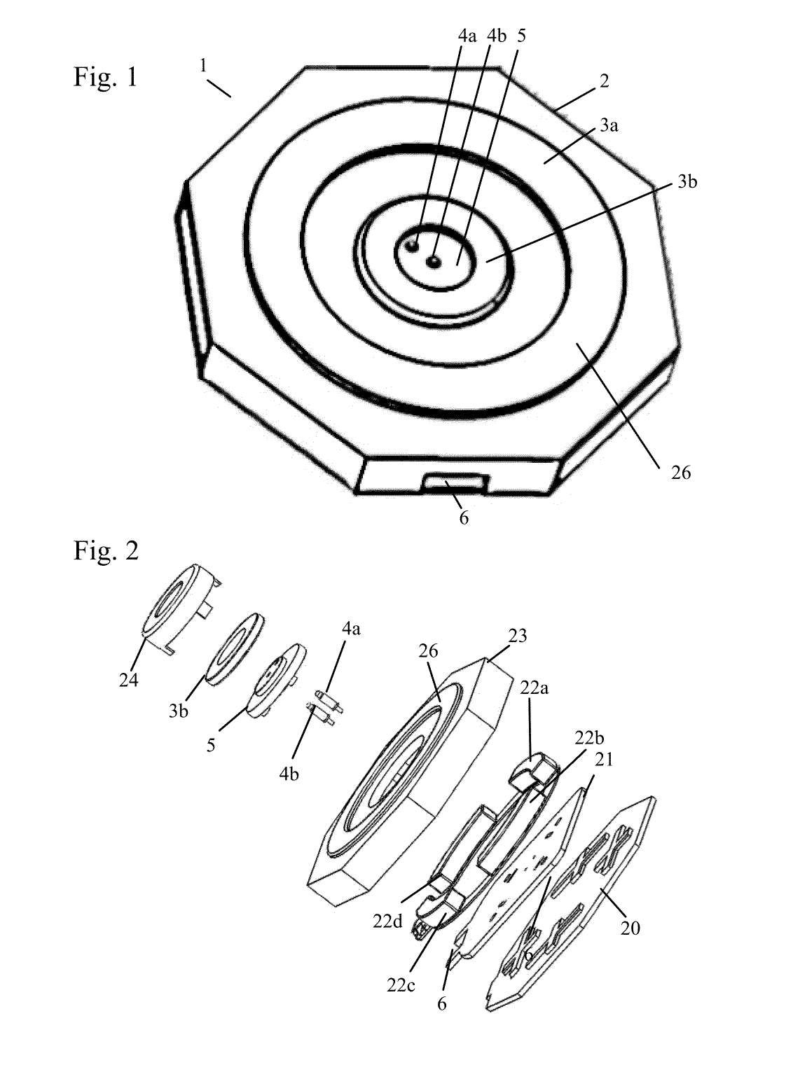

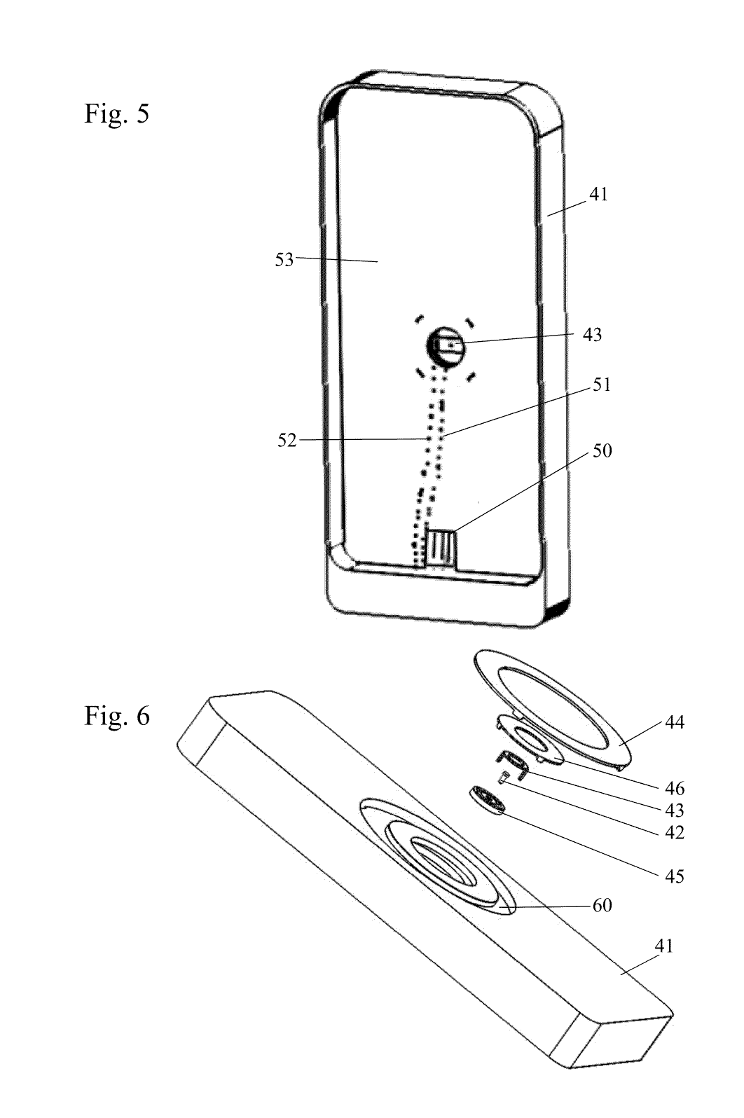

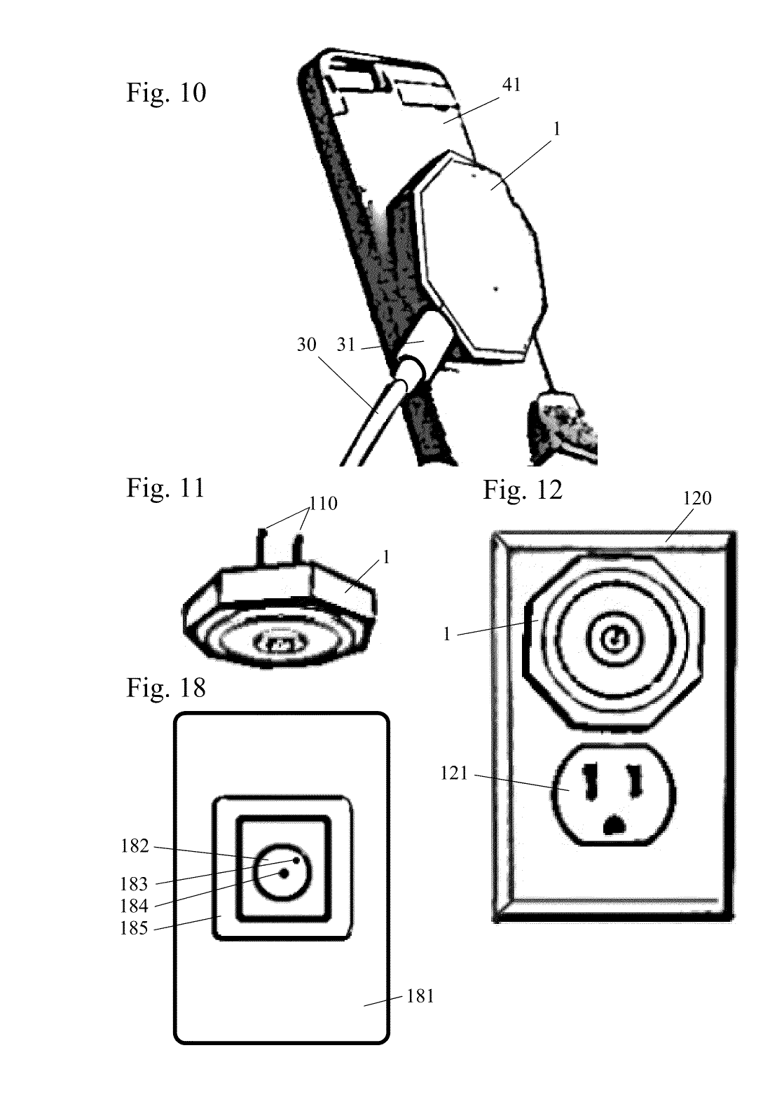

Referring to FIGS. 1-12, the major parts of the system of the invention are a magnetic charging base 1 and a mobile device case 41.

The invention provides a compact solution integrated with a mobile device case 41 allowing a user to attach their phone or other mobile device 90 to the device case 41 and dock it to the charging base 1 with one hand-motion. The device case 41 is held on the charging base 1 through magnetic force between magnets 3a and 3b in the base 1 and magnetic material plates 44 and 46 in the case 41.

FIG. 1 shows a front view of the charging base, and FIG. 2 shows an exploded view. The charging base has a body 2 made up of a front cover 23 and a back cover 20 encasing all of the components of the charging base. The front cover 23 has a circular surface ring 26 for centering the mobile device case 41, as will be explained below. A printed circuit board (PCB) 21 is mounted inside the body 2.

As can be seen in these figures, a number of magnets—in this embodiment, two magnets 3a, 3b—are mounted on the front cover 23 of the body 2. The magnets 3a and 3b are preferably in the form of annular rings, arranged in a concentric circular pattern, as shown in the figures. The inner magnet 3b may be contained in a separate housing 24, while the outer magnet 3a may be mounted inside the body 2. The outer magnet 3a may be a continuous ring which forms the surface ring 26 as shown in FIG. 1, or constructed in segments 22a-22d inside or coincident with the ring 26 on the surface of the body 2 as shown in FIG. 2. The magnets 3a, 3b are preferably chosen such that they exert an attraction which is strong enough to securely hold a mobile device 90 with all the obstacles encountered by moving vehicles, but weak enough so that detaching the device case 41 will not compromise mounting base 1 integrity.

The open central area inside the inner magnet 3b contains a pair of contact pins 4a and 4b, held in an insulated housing 5. One of the pins 4b is centered on the axis of the magnet ring 3b, and the other pin 4a is offset to one side.

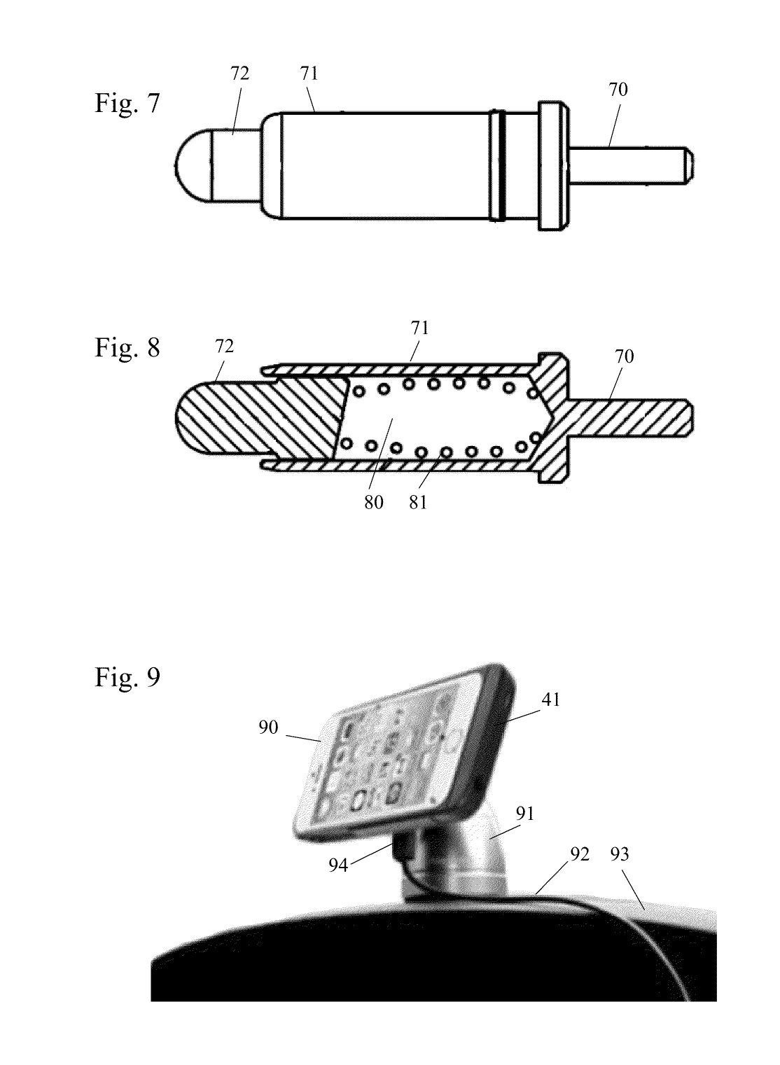

The contact pins 4a, 4b of the charging base are preferably of the design known as “Pogo Pins”, as shown in FIGS. 7 and 8—but it will be understood that while the pins are referred to herein as “pogo pins”, other forms of contacts such as bent spring-metal or spring contacts can be used within the teachings of the invention. Some degree of resiliency is preferred in the contact pins, so that the pins 4a, 4b can maintain positive electrical contact with the contacts 42, 43 when the device case 41 is mounted on the base 1, as will be explained in detail below.

The PCB 21 has an appropriate charging connector 6 for connecting the base 1 to a power source. In the drawings the connector 6 is shown as a micro-USB connector. It will be understood that this connector is conventional, and can be anything known to the art, such as one of the mini-USB or micro-USB varieties, or a coaxial connector, or an Apple connector such as Lightning® or 30-pin. The charging connector 6 can be connected directly to the pins 4a, 4b, or the PCB 21 may contain circuitry for converting voltage, limiting current, communicating with the battery in the device, or other tasks conventional to chargers. By appropriate circuitry on the PCB 21, the base 1 can be adapted for use with tablets with higher voltage or current capacity, or otherwise to account for charging requirements.

Pogo pins are shown in more detail in FIGS. 7 and 8. As can be seen in these drawings, the pogo pins have a cylindrical housing 71 on a pin 70 for soldering to the printed circuit board (PCB) 21 inside the body 2 of the charging base 1. A spring 81 inside the interior 80 of the cylindrical housing 71 biases a contact surface on plunger 72 outward, so as to exert a contact force on the matching contacts 42 and 43 on the device case 41. The contact surfaces of the plungers 72 of the pogo pins are preferably gold-plated to minimize contact resistance. This pogo pin design ensures low resistance and low heat with electrical current.

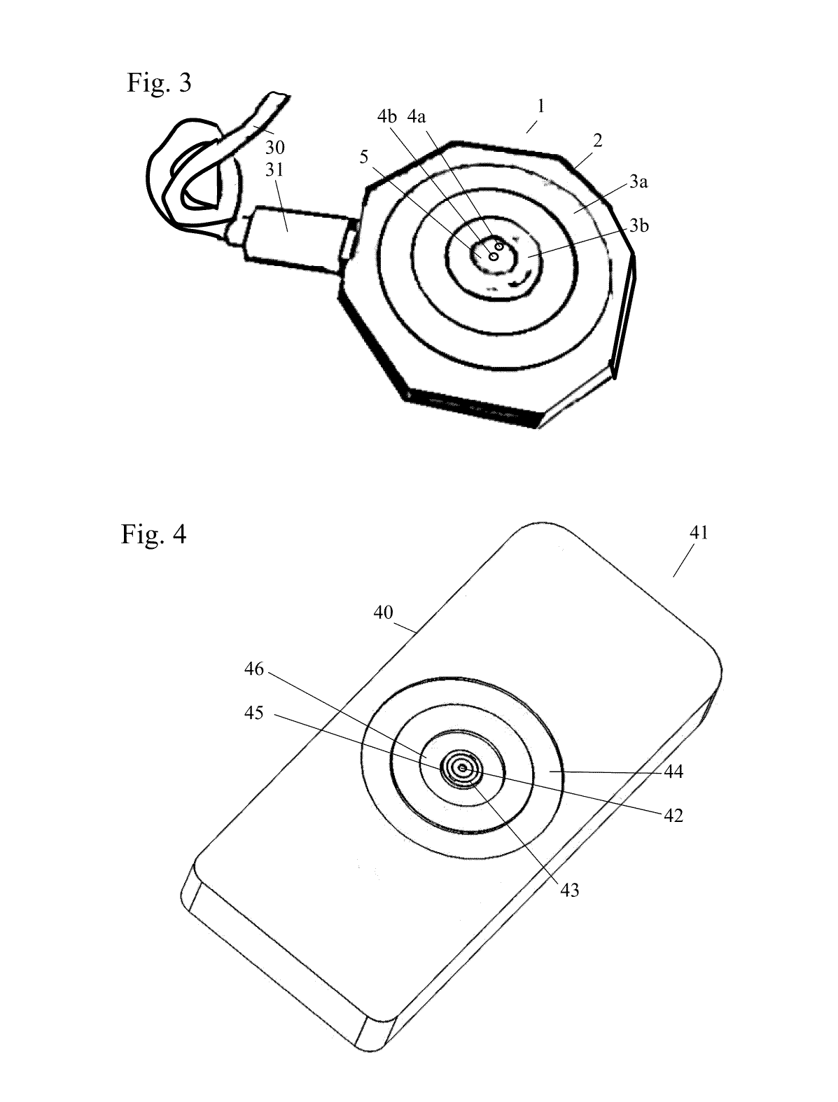

As shown in FIG. 9, a conventional mount 91, such as a suction or adhesive mount, can be used to mount the charging base 1 in a vehicle 93. Power can be supplied by a conventional cigarette lighter plug (not shown) feeding 12V from the vehicle's electrical system to a wire 92 having an appropriate connector 94 plugged into the charging connector 6 on the base 1. In home applications, as shown in FIG. 3, the charging base 1 can simply be placed on a desk or other surface, and a cord 30 with appropriate connector 31 can be used to connect the base 1 to a power supply such as the ubiquitous “wall wart” encapsulated supply (not shown).

Alternatively, as shown in FIG. 11, in place of a charging connector 6 connected to an external supply, conventional AC plug pins 110 can be mounted on the rear cover 20 of the base 1, with appropriate voltage conversion circuitry in the PCB 21. In that embodiment, as shown in FIG. 12, the base 1 can be plugged directly into a conventional outlet 121 on a wall fixture 120.

FIG. 18 shows an embodiment of the charging base 181 useful with larger devices such as tablet computers. In this embodiment, the magnet 185 is larger and squarer than in the previous embodiments for smaller devices. As in the other embodiments, an insulated housing 182 holds pins 183 and 184 in a central location inside the magnet 185.

The mobile device case 41, shown in FIGS. 4-6 and 10, houses the mobile device 90 (cell phone, GPS, MP3 player, etc.) and attaches the mobile device 90 to the charging base 1.

As can be seen in FIG. 4, the mobile device case 41 has a body 40 with one or more magnetic material or ferrous plates 44, 46—preferably steel rings of similar size and shape to the magnets 3a, 3b in the base 1, as shown in the drawings. The plates 44, 46 are preferably mounted in a circular recess 60 on the back of the mobile device case 41. The ferrous plates 44, 46 are attracted by the magnets 3a, 3b in the charging base 1, and the circular recess 60 of the back of the device case 41 fits with the circular surface ring of the charging base 1 to center the device case on the charging base and allows the mobile device to turn 360 degrees on the mount.

In the open central area of the inner plate 46 is a pin housing 45 on which are mounted contacts 42 and 43. One of the contacts 42 is located in the center of the circular recess, and the other contact 43 is in the form of a ring, having a radius such that the offset pogo pin 4a on the charging base will contact the ring 43 whatever the angular orientation of the device case 41 on the charging base 1.

The front or inside 53 of the device case 41, where the mobile device 90 is housed, is fitted with a connector 50 appropriate to the device, which is wired to the female contacts 42, 43 on the back of the device case 41. The connector 50 will be chosen in type and location to match whatever device is to be housed in the device case—for example, Apple iPhones® or iPods® would need either Lightning® or 30-pin connectors, or Android® phones might need one of the mini- or micro-USB connectors. A GPS might need a micro-USB mounted on the flat rear side of the inside of the device case. The connector 50 could be mounted on short flexible wires for a more generic connection, as desired.

The wiring 51, 52 from the device case female contacts 42, 43 to the mobile device 90 through the connector 50 allows the device to be connected instantly to the charging current when the device case 41 is placed onto the charging base 1.

Part shapes can be changed without changing the invention, such as, mobile device case shape and size, the shape and size of the magnetic mounting base as well as the corresponding magnetic mounting contact housing.

FIG. 9 shows how the charging base 1 can be mounted 91 on or integrated into a control panel and dashboard 93 of a car. FIG. 17 shows how a charging base 1 can be integrated onto a car's dashboard or control panel 170 to avoid visible power wires. In that case, the charging base 1 can be mounted in a vertical position 172 or 173 to hold mobile devices 90 while charging, navigating, or conducting phone calls. Alternatively, the charging base 1 can be mounted in a horizontal location 171 or 174 to hold a mobile device 90 while charging. It is possible to make the charging base 1 in a smaller size, which looks like the buttons of the car's instrument panel, so as to add a charging base without sacrificing the beauty of the car's interior.

The combined charging base and device case can be used in locations other than a vehicle such as at a workstation, in a restaurant (for a portable order device), with cameras for still photography or video, in stores for hand-held barcode scanners, or in homes or offices. The charging base can also be embedded in or mounted on a wall vertically—for example, as shown in FIG. 12, it can be built into a standard electrical outlet cover 120.

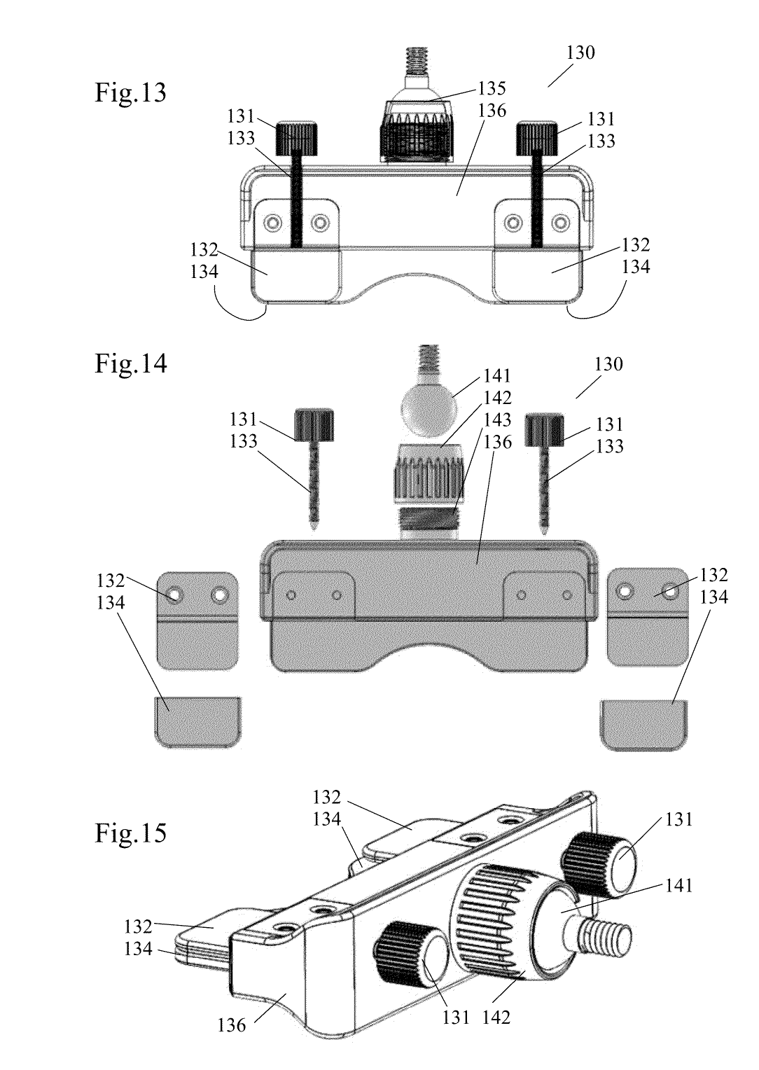

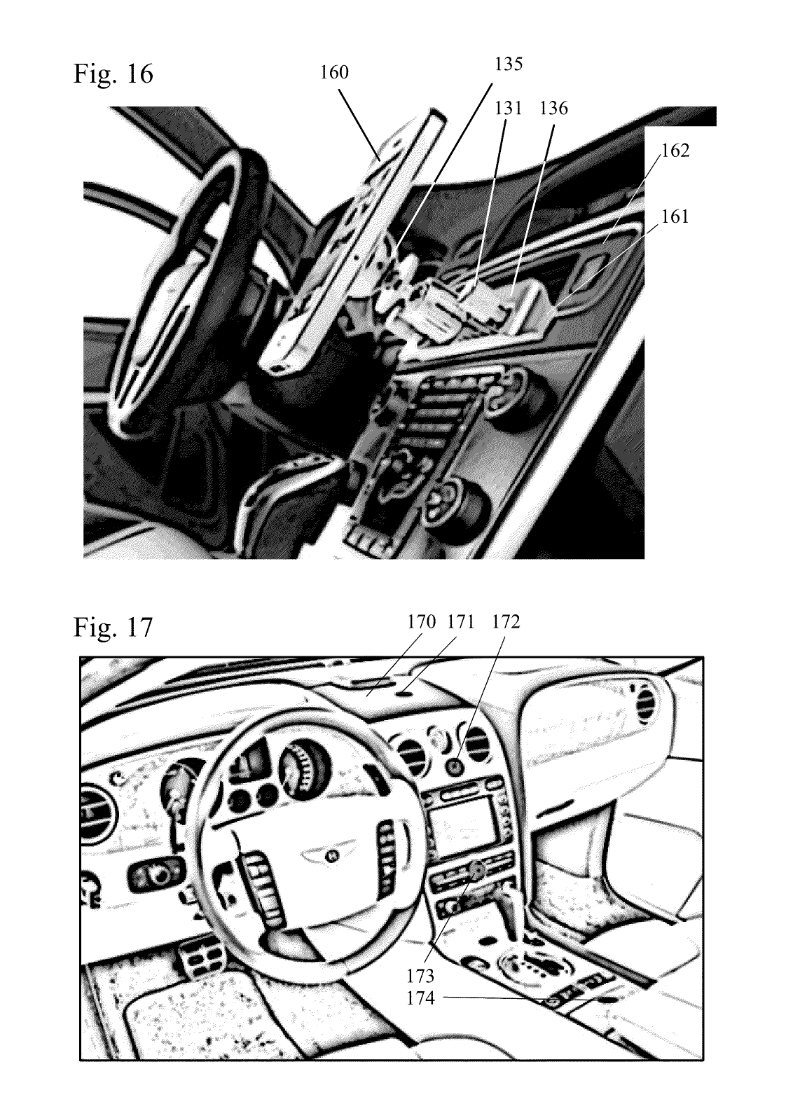

FIGS. 13-16 show another embodiment of a mount for the charging base 1, in which the base 1 is attached to a mount 130 which inserts into the CD slot 161 in a car CD player 162. The charging base 1 for the mobile device 160 is mounted to the mount 130 by a conventional attachment, such as the swivel ball mount 135 shown in the figures and described below. Alternatively, some other attachment might be used as known to the art, such as flexible shaft or a number of individual shafts and flexible connections.

As can be seen in FIGS. 13-15, the mount 130 has a main body 136 with an integrated edge and two elastic steel plates 132, 134 on each side. When the mount 130 is inserted into the CD slot 161, the two elastic steel plates 132, 134 with rubber covers will be expanded by adjusting two thumb screws 131, which are connected to plates 132, 134 by threaded shafts 133, so that the mount can stabilize in the CD-slot.

The swivel ball mount 135 is made of a ball 141 with a standard (¼-20) camera screw thread, which is captured to the swivel base 143 by a threaded collar 142. When the collar 142 is loose, the ball 141 can rotate freely about the axis of the screw, and the axis can be angled to adjust the charging base on the screw to a desired mount angle for the device 160. When the collar 142 is tightened, friction holds the ball 141 between the collar 142 and the base 143. This structure allows an attached device to turn through 360 degrees and swivel through 45 degrees or more. This also makes it easy to mount additional objects (e.g. our charging base, magnetic head, camera, et al).

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A mounting and charging system for a mobile device, comprising:
a) a charging base comprising:
a body having a front cover and a charging connector;
at least one magnet on the front cover, having an open central area; and
a first pin and a second pin on the front cover, within the open central area of the at least one magnet, the first pin and the second pin being electrically coupled to the charging connector; and
b) a device case comprising:
a body for holding a mobile device, having a back surface and a front surface for attaching to the mobile device;
at least one plate made of magnetic material on the back surface of the body, having an open central area;
a first contact and a second contact on the back surface of the body, within the open central area of the at least one plate,
the first contact and the second contact being located such that when the device case is held on the charging base by the at least one magnet to the at least one plate, with the at least one plate centered on the at least one magnet, the first pin of the charging base contacts the first contact of the device case, and the second pin of the charging base contacts the second contact of the device case.

2. The mounting and charging system of claim 1, in which:
the at least one magnet of the charging base is in the form of an annular ring having an axis;
the first pin is located on the axis of the at least one magnet;
the second pin is offset a distance from the axis of the at least one magnet;
the at least one plate of the device case is in the form of an annular ring having an axis;
the first contact is located on the axis of the at least one plate; and
the second contact is in the form of a flat annular ring centered upon the axis of the at least one plate, the flat annular ring having a radius approximately equal to the offset distance of the second pin, such that when the device case is held on the charging base by the attraction of the at least on magnet to the at least one plate, the second pin contacts the second contact regardless of rotational orientation of the device case about the axis of the at least one plate.

3. The mounting and charging system of claim 2, in which the front cover of the charging base further comprises a circular surface ring centered on the axis of the at least one magnet, and the back surface of the device case has a circular recess centered on the axis of the at least one plate, such that when the device case is held on the charging base by the attraction of the at least on magnet to the at least one plate, the circular surface ring fits into the circular recess.

4. The mounting and charging system of claim 1, in which the first pin and the second pin are pogo pins.

5. The mounting and charging system of claim 1, in which the at least one magnet of the charging base comprises two magnets in the form of two concentric annular rings.

6. The mounting and charging system of claim 1, in which the at least one plate of the device case comprises two plates in the form of two concentric annular rings.

7. The mounting and charging system of claim 1, in which the device case further comprises a charging connector for mating with the mobile device, electrically coupled to the first contact and the second contact.

8. The mounting and charging system of claim 1, in which the charging connector of the charging base is coupled to the first pin and the second pin through a charging circuit.

9. The mounting and charging system of claim 1, further comprising a mount for mounting the charging base to a surface.

10. The mounting and charging system of claim 9, in which the mount comprises a swivel ball mount.

11. The mounting and charging system of claim 9, in which the mount comprises a CD-slot mount comprising a body having two expanding plates for insertion into a CD-slot on a car stereo, each expanding plate being expandable in thickness by a screw passing through the body, such that expanding the plates in thickness locks the mount into the CD-slot.

12. The mounting and charging system of claim 11, in which the mount further comprises a swivel ball mount attached to the body opposite the two plates.
